(19) United States
(12) Patent Application Publication
(10) Pub. No.: US 2023/0340214 A1
(43) Pub. Date: Oct. 26, 2023

(54) SANITARY ARTICLE AND METHOD FOR PRODUCING SUCH AN ARTICLE

(71) Applicant: Duravit Aktiengesellschaft, Hornberg (DE)

(72) Inventor: Thomas STAMMEL, Hornberg (DE)

(21) Appl. No.: 18/133,206

(22) Filed: Apr. 11, 2023

(30) Foreign Application Priority Data
Apr. 21, 2022 (DE) 10 2022 109 646.7

(51) Int. Cl. C08J 5/04; C08J 7/04; C08K 3/013

(52) U.S. Cl. CPC C08J 5/043; C08J 7/04; C08K 3/013; C08J 2363/00; C08J 2497/02; C08K 2201/00

(57) ABSTRACT

A sanitaryware article having a support formed from a cured resin having embedded reinforcing fibers, which defines the shape of the sanitaryware article and which at least on a facing side bears a cured gelcoat layer.

### CROSS-REFERENCE TO RELATED APPLICATIONS

The present application claims priority of DE 10 2022 109 646.7, filed Apr. 21, 2022, the priority of this application is hereby claimed, and this application is incorporated herein by reference.

### BACKGROUND OF THE INVENTION

The invention relates to a sanitaryware article.

Sanitaryware articles in the form of bath tubs, shower trays, wash consoles or wash basins and the like are increasingly being produced from a composite material, often also called “solid surface”. For its production a corresponding material is provided, consisting of a curable resin as the basis, with a curing agent usually being added for curing. The resin is usually a polyester resin, an acrylic resin or a polyester resin modified with acrylic monomers. The curative used is usually a methyl ethyl ketone peroxide (MEKP). The material, furthermore, additionally comprises organic and/or inorganic additives such as, for example, pigments, antibacterial agents, flame retardants such as ATH, and also reinforcing agents such as glass beads and the like. The fluid material is poured into a mold, where it subsequently cures and after curing can be demolded. Using such a mold it is also conceivable to produce undercuts and similar three-dimensional structures if using a corresponding mold having corresponding sliders or wedges, etc. In this way it is possible to produce high-quality, visually appealing sanitaryware articles.

A disadvantage is that such sanitaryware articles, especially if they are relatively large, such as bath tubs or shower trays or long wash consoles, for example, are relatively heavy. This is a result of the wall thickness of the sanitaryware article being made large enough to provide the required mechanical properties, particularly in respect of mechanical loads, and also corresponding thermal loads, to which such sanitaryware articles are subject. The high weight not only makes transport and assembly costly and complicated; instead, it also entails a high level of material consumption, which is a disadvantage not least for environmental reasons.

It is also known practice to produce sanitaryware articles such as bath tubs or shower trays by thermoforming an appropriately dimensioned acrylic resin plate. As the acrylic resin plate is relatively thin, it is necessary to provide it with appropriate stabilization on the back side, for which a reinforcing layer is applied to the back side of the thermoformed acrylic component, this reinforcing layer consisting of a—typically glass fiber-reinforced—polymer coating, optionally in conjunction with integrated stiffening plates and the like.

It is indeed possible to use thermoforming to produce a three-dimensional acrylic article which has very small or narrow undercuts and the like. Larger undercuts, however, of the kind which can be produced, for example, by shaping with a casting material, cannot be produced with these processes. A further disadvantage of the thermoforming process is that the thickness of the formed acrylic layer varies over the area. The greater the deformation of a region, the thinner the acrylic layer on the finished product. This is the case in particular in the region of bends or corners and angles. The greater the deformation, the thinner the acrylic layer, and in an extreme case this may even lead to the back-side reinforcement being visible to a small extent through the acrylic layer. That is disadvantageous and undesirable. A further perceived disadvantage is the greatly reduced possibility of coloring within the acrylic layer. It is indeed possible in principle to use a colored acrylic plate. However, at more greatly reshaped regions, there are instances of stretching within the molecular chains of the acrylic matrix, with the consequence that in these regions there is a change in color—typically, the colored acrylic in these regions becomes lighter or paler. For this reason, relatively dark articles cannot be produced from such a material.

### SUMMARY OF THE INVENTION

The invention is based on the problem of specifying a sanitaryware article which is an improvement by comparison.

To solve this problem, the invention provides a sanitaryware article consisting of a support which is formed from a cured resin having embedded reinforcing fibers, which defines the shape of the sanitaryware article and which at least on a facing side bears a cured gelcoat layer.

The sanitaryware article of the invention consists at its most simple of two layers, namely the actual support which defines the three-dimensional shape of the sanitaryware article. This support is formed from a cured resin in which reinforcing fibers are embedded. These reinforcing fibers may preferably be glass fibers, although aramid fibers or carbon fibers or polymer fibers are also conceivable. The purpose of these fibers is to provide the resin matrix with further stiffening in order to increase the mechanical strength of the support.

At least the facing side of the support bears a cured gelcoat layer which is visible from the facing side of the sanitaryware article. This gelcoat layer is made of a hardcoat material and consists generally of a synthetic resin admixed with silica. The synthetic resin, i.e. the actual resin basis, which is used is usually unsaturated polyester or an epoxy resin. The resin is entirely fiber-free, allowing a visually flawless, undisrupted coating layer to be formed. The added silica makes the surface of the coating layer more abrasion-resistant. Since the coating layer is a layer which is applied in fluid form and subsequently cures, it is possible to achieve a uniform gelcoat layer covering over the entire area on which the gelcoat layer is applied. It is also readily possible to use any desired coating colors, since the polymer basis, i.e. the resin, can be admixed with any desired color pigments. Owing to the fact that, because of the fluid application, there are no mechanical loads at all in the course of curing that would lead in any form to changes in color, it is possible to achieve an entirely uniformly colored coating layer.

Because the support is produced from a fluid material, specifically the curable resin with embedded reinforcing fibers, and the cured gelcoat layer is produced from a fluid material, it is also readily possible to produce articles of more complex shape with correspondingly large undercuts of the kind provided, for example, in the case of bath tubs or shower trays, especially at the edge of the respective tub or tray. This means that there is a wide spectrum of geometries that can be produced, in conjunction with virtually infinite coloring on the facing side of the sanitaryware article.

As the resin of the support, it is possible to use an epoxy resin, a polyester resin, an acrylic resin, a vinyl ester resin or derivatives thereof, this listing not being exhaustive. Since curing is usually reactive, a corresponding curing agent such as MEKP, for example, is to be added, and optionally an accelerator as well, as an additional additive.

The reinforcing fibers may be relatively short fiber pieces, having for example a length of 1-35 mm, preferably 1-25 mm. The fiber pieces ought to have a diameter or thickness of 10-15 μm, preferably between 10-13 μm. The fiber length may be selected according to the manner of processing. Where the support material is processed by spraying, relatively short fibers are preferred, since they make the spraying operation easier. If the support material is applied, for example, with a fine brush or a roller, relatively long fibers may be used, with the longer fibers providing the possibility of achieving even better anchorage and hence reinforcement.

Instead of the use of short fiber pieces, it is also conceivable for the fibers to take the form of fiber mats, which are therefore embedded as more extensive mat portions into the polymer matrix or resin matrix of the support material and which are present in the cured support material on the final sanitaryware article. The fiber mats ought in this case to have a mat weight of 200-600 g/m².

It is conceivable, furthermore, to embed plate-shaped or strip-shaped or profile-shaped reinforcing elements in the support at one or more positions. Particularly in the case of relatively large sanitaryware articles such as a bath tub or shower base, for example, it is useful to embed additional reinforcing elements on the support side, in the edge region or in the base region, for example. It is conceivable to embed strip-shaped or profile-shaped—that is, elongate—reinforcing elements all round at the edge of the bath tub or shower base, for example, whereas in the base region of the tub or base one or more plate-shaped reinforcing elements can be integrated. By these means it is possible in a targeted way to provide additional local reinforcement, particularly in regions which are subject to increased mechanical stress in the course of usage.

A reinforcing element of this kind may be made, for example, of wood, plywood, laminated wood, a laminate, more particularly a fiber laminate, or metal, or may be implemented as a fiberboard. It is therefore possible to use a wide variety of different reinforcing elements, provided they can be embedded sufficiently into the polymer matrix of the support. As part of the production, it is possible, for example, to apply a first support material layer, after which the one or more reinforcing elements are applied to the support material layer, after which a second support material layer is applied which then finally embeds the reinforcing elements. In the course of this it is of course also possible to introduce corresponding reinforcing fibers, whether in the form of fiber pieces or of fiber mats.

The gelcoat layer itself may consist of a polyester resin, a vinyl ester resin or an epoxy resin as polymer matrix, this listing not being exhaustive. As has already been indicated, the layer may include color pigments, i.e. may be colored, in which case, as stated, it is possible to achieve an entirely uniform coloration over the entire coating area. Alternatively or additionally there may also be an antibacterial agent included, e.g. silver ions, this being a particular advantage since the articles in question are sanitaryware articles.

The thickness of the cured gelcoat layer ought to be between 0.4-1.5 mm, more particularly between 0.5-1.0 mm. The gelcoat or hardcoat layer is therefore very thin, compared with the significantly thicker, cured support thickness, which ought to be in the range of 5-20 mm, more particularly 8-15 mm. Because it is a fluid material, a thin gelcoat layer of this kind can be applied easily and homogeneously, by spraying, for example.

The support in accordance with the invention ought to have a thickness of 0.5-12 mm in a region without reinforcing element and 0.5-6 mm in a region with reinforcing element.

The “substrate” on which the gelcoat layer is applied, in other words the area of the support that faces the facing area, may be planar, i.e. unstructured and therefore smooth. Alternatively it is also conceivable for this support area to have at least in portions a surface structuring which is also reproduced in the gelcoat layer. Such surface structuring may be, for example, a nubbed or ripple structure with elongate, straight or wavy elevations, via which, for example, an anti-slip surface can be formed. It is also conceivable to configure the surface structuring in the manner of a wood appearance, in other words a kind of graining. Since the structuring is also reproduced by the gelcoat layer, which as described is very thin, it is therefore perceptible on the surface in tactile form as well as visibly.

The sanitaryware article itself is preferably a bath tub or a shower tray, thus being a relatively large, tub- or tray-shaped article which in particular at the edges often also has relatively complex structures and which is exposed to considerable mechanical loads, since usually in the course of this usage there is at least one person on the sanitaryware article.

As well as the sanitaryware article itself, the invention relates further to a process for producing such a sanitaryware article. This process is notable, according to a first process alternative, for steps as follows:
providing a mold and applying a fluid gelcoat material to an area of the mold
curing the gelcoat material to form a gelcoat layer
applying a fluid support material comprising a resin and reinforcing fibers to the gelcoat layer and also optionally one or more reinforcing elements
curing the support material to form the support
removing the sanitaryware article from the mold.

In this invention variant, the sanitaryware article is formed completely in a mold. In terms of sequence, after the mold has preferably been first prepared by cleaning and sealing, the gelcoat material is first introduced and cured, meaning that the gelcoat layer is formed first in the mold. The support material together with the reinforcing fibers is subsequently applied to this cured gelcoat layer, and also, optionally, the one or more reinforcing elements are embedded in it, after which the support material is cured. In the mold there is then the finished sanitaryware article, consisting of gelcoat layer and support, and the article is then demolded.

If the nature of the sanitaryware article requires the embedding, additionally, of one or more reinforcing elements, then for embedding the one or more reinforcing elements first a first partial layer of the support material can be applied, after which the one or more reinforcing elements are applied to the first partial layer, after which a second partial layer of the support material, embedding the reinforcing elements, is applied to the first partial layer and the one or more reinforcing elements. The support material, accordingly, is applied in at least two layers, where before the second partial layer is applied the reinforcing elements are applied to the first partial layer and embedded therein. In that case, in each of the partial layers or layers of material, there can be a fiber fraction included whether comprising short fiber pieces or comprising inserted fiber mats.

After the finished sanitaryware article has been demolded, subsequent work may be done on a facing side of the sanitaryware article, formed by the gelcoat layer. This working may be, for example, a sandblasting operation or a grinding operation by which the gelcoat or hardcoat layer is slightly delustered, or similar.

It is additionally conceivable, after the demolding, and optionally before the working of the surface, for one or more edge portions of the sanitaryware article to be worked or to be joined, more particularly bonded, to one or more further components. Sometimes, for the final assembly, it is intended that a further component should be mounted on the sanitaryware article itself, such as, for example, a skirt or the like to finish off toward the base. For this purpose, the one or more portions on the sanitaryware article, in other words, for example, corresponding angles or the like, are worked mechanically so as to provide a securement interface at which the component is attached. This attachment is accomplished preferably by bonding with resin. For this purpose the material of which the gelcoat layer as well is made is preferably used.

A second process alternative of the invention for producing a sanitaryware article provides steps as follows:
providing a mold and applying a fluid support material comprising a resin and reinforcing fibers and also optionally one or more reinforcing elements to an area of the mold
curing the support material to form a support
removing the support from the mold
applying a fluid gelcoat material to an area of the support
curing the gelcoat material to form a gelcoat layer.

In the case of this process variant, only the support is produced in the mold, and defines the three-dimensional shape of the final sanitaryware article. For this purpose, a fluid support material comprising resin and reinforcing fibers is applied to a mold surface, and if necessary, one or more reinforcing elements are embedded. This is followed by the curing of the support material, to form a finished, cured support. This support is then removed from the mold, after which a fluid gelcoat material is applied to the side or area of the support that defines the facing side of the finished sanitaryware article. In other words, the coating with the gelcoat material takes place outside the mold. Following application, the gelcoat material cures to form the final gelcoat layer.

Here as well it is useful, for embedding one or more reinforcing elements, first to apply a first partial layer of the support material, after which the one or more reinforcing elements are applied to the first partial layer, after which a second partial layer of the support material, embedding the reinforcing elements, is applied to the first partial layer and to the one or more reinforcing elements, embedding them.

Here as well, after the formation of the gelcoat layer, a facing side of the sanitaryware article, formed by the gelcoat layer, may be afterworked, by sandblasting, grinding or the like, for example, in order, for example, to achieve delustering.

Additionally, after the curing of the gelcoat layer, and optionally before the working of the surface, one or more edge portions of the sanitaryware article may be worked and joined, more particularly bonded, to one or more further components, as already described for the aforementioned first alternative.

For both process variants of the invention it is the case that the gelcoat material ought to be cured at a temperature of 35° C.-55° C. for a time of 5-20 mins and the support material at a temperature of 35° C.-55° C. for a time of 1-2 hours. Both for the gelcoat material and for the support material, the curing temperature ought preferably to be between 40° C.-50° C., more particularly in the region of 45° C. The gelcoat curing time ought preferably to be around 15 min; the time for curing the support material ought to be around 1.5 h. The respective curing times are selected in particular in dependence on the applied thickness both of the gelcoat material layer and of the support material layer.

The gelcoat material and/or the support material are applied preferably by spraying, hence with the aid of a spray gun. This is no problem in the case of the gelcoat material which contains no fibers. The support material with relatively short fiber pieces as well can easily be applied by spraying. The same is true of the application of the support material by the fiber spraying process when using fibers in the form of continuous bundles or rovings, where the fibers are brought to their final length only during the actual spraying. If the support material does not contain any fiber pieces, these fibers instead being applied in the form of fiber mats, then spraying is automatically not a problem. Alternatively, the support material may also be applied by fine or coarse brush.

The gelcoat material used may comprise the following:
resin: 85-95 wt %
pigment: to 7 wt %
antibacterial agent: to 0.5 wt %

The sum total is of course 100 wt %, including any other additions.

The resin used in the gelcoat material may be polyester resin, vinyl ester resin or epoxy resin, this listing not being exhaustive. As pigments it is possible to use any desired color pigments, primarily inorganic in type, which are used in the coatings sector. As antibacterial agent it is possible for example to introduce metal ions, more particularly silver ions.

The composition of the support material used may be as follows:
resin: 40-74 wt %
curing agent: 1-3 wt %
glass fiber: 10-25 wt %
filler: 0-50 wt %

Two variants of the composition of the support material may be formulated as follows:

1^{st} Variant:
resin: 40-60 wt %
curing agent: 1-3 wt %
glass fiber: 10-13 wt %
filler: 30-50 wt %
or

2^{nd} Variant:
resin: 56-74 wt %
curing agent: 1-5 wt %
glass fiber: 10-25 wt %
filler: 0-30 wt %.

The sum total is of course 100 wt %, including any other additions. The fraction of the particulate filler is always in addition to the glass fiber.

As the resin of the support material, i.e. as the means forming the polymer matrix, it is possible to use epoxy resin, polyester resin, acrylic resin, vinyl ester resin or derivatives thereof, this listing not being exhaustive. As curing agent it is possible for example to use MEKP, optionally additionally with an accelerator which contains, for example, cobalt. As glass fibers it is possible as described to use fiber pieces or fiber mats. Fillers used may be, for example, inorganic fillers in the form of quartz sand or similar particles, or else glass beads, via which the weight can additionally be reduced, and the like.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

FIG. 1 shows a partial view in section of a sanitaryware article of the invention in a first embodiment,

FIG. 2 shows a partial view in section of a sanitaryware article of the invention in a second embodiment,

FIG. 3 shows a partial view in section of a sanitaryware article of the invention in a third embodiment,

FIG. 4 shows a partial view in section of a sanitaryware article of the invention in a fourth embodiment,

FIG. 5 shows a flow diagram for elucidating the process of the invention according to a first invention alternative,

FIG. 6 shows a flow diagram for elucidating the process of the invention according to a second invention alternative, and

FIG. 7 shows a sectional view of a bath tub of the invention.

### DETAILED DESCRIPTION OF THE INVENTION

FIG. 1 shows a partial view in section of a sanitaryware article 1 of the invention, for example a partial view of a shower tray. The sanitaryware article 1 consists of a support 2 composed of a cured resin with reinforcing fibers embedded therein—this will be addressed below. Besides such fibers, there may also be further fillers, for example sand or glass beads or the like, embedded in the support material matrix.

FIG. 1 also shows the possibility of embedding in the support 2 or the support material, one or more reinforcing elements 3, which here are strip-shaped or plate-shaped, but may also be profile-shaped or configured in the form of honeycomb structures and the like. The reinforcing elements 3 are completely surrounded by the support matrix, and so are not visible.

Applied on the support 2 is a gelcoat layer 4, which likewise consists of a cured resin into which, optionally, color pigments have been introduced, so that the facing side 5 of the sanitaryware article is formed via this gelcoat layer, i.e. the hardcoat layer. The gelcoat layer 4 is applied on all areas of the support 2 which are visible in the assembled position of the sanitaryware article 1. On the non-visible back side or underside of the support 2, accordingly no application is required.

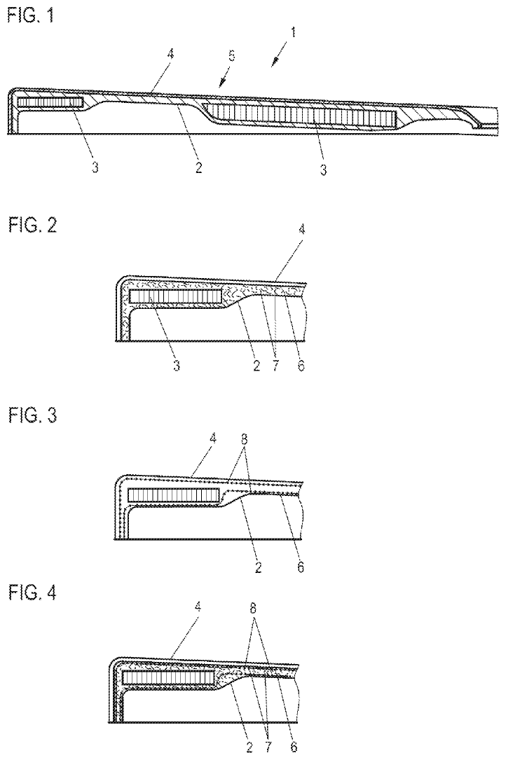

FIGS. 2-4 show different embodiment variants relating in particular to the configuration of the support 2. In FIG. 2, which shows a partial view of the sanitaryware article from FIG. 1, the support 2 is formed via a cured resin matrix or polymer matrix 6 in which in turn a multiplicity of reinforcing fibers are embedded in the form of relatively short fiber pieces 7. These are preferably glass fiber pieces having a length of preferably 1-35 mm, with a preferred thickness of 10-15 μm. The shorter the fiber pieces, the more easy it is to apply the fluid support material, consisting of the fluid resin and the fiber pieces, by spraying.

FIG. 3 shows an embodiment in which the support 2 consists of the resin matrix or polymer matrix 6 in which a plurality of mats 8, which extend more extensively in the resin matrix or polymer matrix 6, have been introduced as reinforcing fibers. Here, in the course of the production process, first a first, relatively thin partial layer of the fluid support material is applied, by spraying, for example, after which a first or plurality of first fiber mats 8 are placed on; the mat weight is preferably between 200-600 g/m². Subsequently, optionally after positioning of a reinforcing element 3, a further partial layer is applied, into which one or more further fiber mats 8 are then pressed, after which, optionally, a further partial layer is applied. In other words, a successive build-up of layers is provided here in order to embed the separate fiber mats 8.

FIG. 4, lastly, shows a variant in which the support 2 again consists of the resin matrix or polymer matrix 6, but additionally comprises not only relatively short fiber pieces 7 but also a plurality of more extensive fiber mats 8. In this case, then, both fiber variants are employed. The fiber mats are likewise made of glass fiber; the mat weight is preferably between 200-600 g/m².

The gelcoat layer 4 is applied by spray or sprayed application of a corresponding curable gelcoat material. The thickness of the coat after curing is in the range of 0.4-1.5 mm, preferably in the range between 0.5-1.0 mm. Particularly in the case of spray or sprayed application, it is possible to achieve a very uniform layer thickness, since the fluid gelcoat material can be sprayed easily, being a coating system which can be applied using a corresponding spray gun or the like.

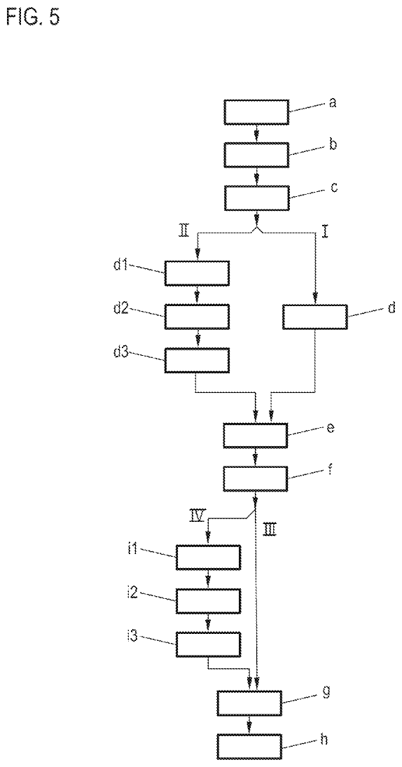

FIG. 5 shows a flow diagram for elucidating a first process variant of the invention. In step a, first, a mold which dictates the shape of the sanitaryware article is provided, cleaned and sealed if necessary. In step b, first, the fluid gelcoat material is applied to an area of the mold, preferably by spray or spraying. This gelcoat material is then cured in step c to form the gelcoat layer, which has corresponding mechanical and optical properties.

Subsequently, with the cured gelcoat layer still located in the mold, the support is formed. Here there are two different process alternatives, namely the first variant, where there is no need to provide one or more reinforcing elements on the support side, or the second variant, wherein one or more reinforcing elements are embedded in the support. The first variant is represented following the arrow I. In this variant, in step d, a fluid support material is applied, preferably here again by spraying, and in the amount needed to form the entire support, to the cured gelcoat layer. The amount of support material is selected so as to produce a layer thickness on the cured support of for example 3-15 mm, more particularly of around 5-12 mm. This means that the support material is formed in one coating pass.

If, however, one or more reinforcing elements of whatever kind are to be applied, the process takes the form according to arrow II. Here, in a first step d1, a first layer of the support material is sprayed onto the gelcoat layer. In step d2, the one or more reinforcing elements are then positioned appropriately, after which, in step d3, a second layer of the fluid support material is sprayed on, and on the one hand is sprayed onto the first partial layer but on the other hand also completely embeds the reinforcing elements. In this case the thickness of the individual support layers may differ from the support layer of the first variant. In particular, the support layers may be thinner, for example between 0.5 mm to 12 mm, more particularly from around 0.5 mm to 6 mm.

It may be noted in this case that the support material is firstly provided from the start with corresponding fiber pieces, preferably made of glass fiber, which are therefore sprayed on with it. Alternatively or additionally, it is also conceivable to embed at least one fiber mat or a plurality of separate mat pieces, which for example, after sprayed application of one layer of support material, are placed on and pressed in, or which, after sprayed application of the first partial layer, are placed on and pressed in, and of which a further one is placed on and pressed in after sprayed application of the second partial layer. In step e, the support material is cured, to then form a cured support. At the end of this step e, the sanitaryware article is finished in terms of its fundamental production. It consists of the cured, fiber-reinforced support and also of the applied, thin gelcoat or hardcoat layer.

In step f, the sanitaryware article is demolded from the mold.

According to whether the sanitaryware article is a one-piece component, or whether a further component is to be attached to the sanitaryware article thus produced, the further procedure takes on the appropriate form. If the sanitaryware article is finished, then, as represented via the arrow III, there can be surface treatment in step g of the facing area, by sandblasting, grinding or polishing, for example, to generate a non-luster surface, for example. In step h there may additionally be, for example, working of angles or the like, in order to form defined interfaces at points where ultimately there is attachment to the surrounding periphery as part of the assembly procedure.

In the event that there is a further component such as a skirt or the like, for example, to be mounted on the sanitaryware article demolded in step f, then further working steps are carried out before step g. Accordingly, in step i1, corresponding angles or corners or the like of the sanitaryware article, where the additional component is to be added on, may be appropriately trimmed or sanded, and thus mechanically worked. In step i2, the sanitaryware article and the component are mated exactly with one another, after which they are joined to one another in step i3, preferably via an adhesive resin. With this procedure as well, the steps g and h then follow.

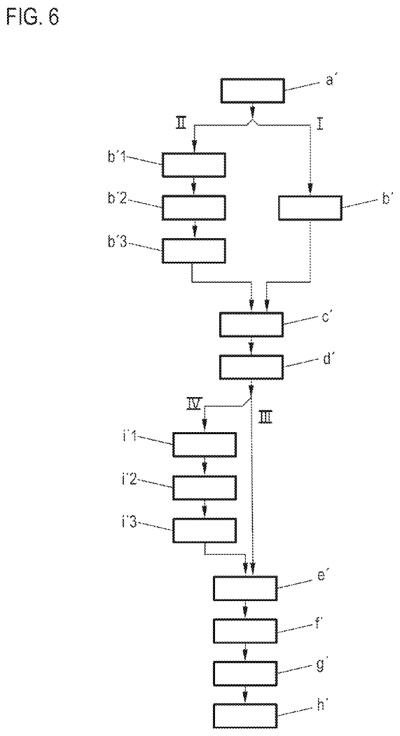

FIG. 6 shows a process variant in which only a part of the sanitaryware article is generated in the mold; the actual finishing, however, takes place outside the mold.

Here as well, in the step a′, first the mold is provided and appropriately cleaned and sealed, i.e. prepared. The support is then formed directly in the mold. Here again there are two different variants conceivable, labeled via the arrows I and II. According to variant I, there are no reinforcing elements to be integrated in the support material, and consequently, according to step b′ therein, the entire support material is applied, more particularly by spraying, into the mold, to the corresponding mold area, until the desired layer thickness has been reached. Following the application, the support material is cured in step c′, so that the entire support is formed in the mold.

Where, however, there are one or more reinforcing elements, governed by the shape of the sanitaryware article, to be embedded in the support, then according to arrow II, in step b′1, first a first partial layer of the support material is applied, more particularly by spraying, after which the one or more reinforcing elements are applied in step b′2. This is followed, in step b′3, by the application of a second partial layer of the support material, which completely embeds the reinforcing elements. In this procedure as well, following application of the second partial layer, the support material is cured in step c′, and so here as well the finished support is then present on the mold side.

It is the case here as well that on the one hand the support material already includes fiber pieces which are introduced into the fluid resin material and are sprayed with it. Additionally or alternatively, as already described, corresponding fiber mats may also be inserted.

In step d′, the support is then removed from the mold. This support then serves, so to speak, as a mold for the application of the gelcoat material.

Here as well there are again two process variants conceivable, which are represented via the arrows III and IV. They differ again in whether the final sanitaryware article is a one-piece component, or is to have an additional component such as a skirt or the like.

The arrow III shows the variant wherein the sanitaryware article is a one-piece component. In step e′, the gelcoat material is applied, more particularly by spraying, to the area of the demolded support that defines the facing area of the finished sanitaryware article. The application can be made very exactly with uniform layer thickness, since the resin coating material can be sprayed on readily in finely metered form.

In step f′ the gelcoat material is then cured. At the end of this curing operation, lastly, the finished sanitaryware article is formed, consisting of the cured support and the cured gelcoat layer.

In step g′ there can then be a surface treatment following, by sandblasting or polishing or the like, for example; as in step h′ there may be an optional angle trim or the like.

Where a further component is to be attached, the process train IV is to be looked at. The demolding in step d′ is followed by a step i′1, in which the angles or corners or the like are worked to form defined interfaces on the support. In step i′2, the support and the component are then aligned accordingly exactly with one another and in step i′3 they are joined to one another, preferably by means of an adhesive resin. The curing of the resin is then followed by step e′ with the application of the gelcoat material, etc.

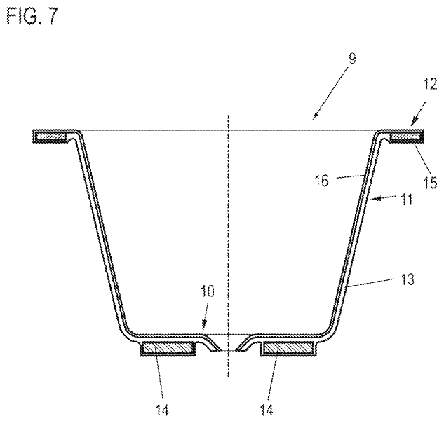

FIG. 7 shows a sectional view of a sanitaryware article of the invention in the form of a bath tub 9. This bath tub 9 has a base 10, all-round side walls 11 and an all-round tub edge 12. It consists of a support 13 made of fiber-reinforced plastic, in which reinforcing elements 14 are embedded on the base 10 and reinforcing elements 15 on the tub edge 12. Applied on the inside of the support 13 is a gelcoat layer 16 made of a hardcoat material.

A bath tub 10 of this kind was produced as a test object. The bath tub 10 of the invention was produced using the following materials:

For the preparation of the mold, Chemlease® 15 Sealer EZ from Chem Trend was used as mold sealant, and Zyvax® WaterShield™ Release Agent from Chem Trend was used as release agent, and they were applied to the casting mold.

For producing the white gelcoat layer gel, an isophthalic resin suitable for spray application, namely GC 188 Isophtalic Gel Coat from KoverTek, Nord Composites was used.

The resin used for the support was a commercial unsaturated orthophthalic polyester resin, unwaxed. The resin used was that obtainable under the name Polycoat SLO 180NT from Aekyung Chemical CO., LTD.

The curing agent used was the curing agent available under the name “Butanox® M-50” from AkzoNobel, an MEKP curing agent.

The glass fiber used was an E-Glass Multi-End-Roving ERS 240-T132BS, suitable for sprayed application, from CTG Taishan Fiberglass Inc. The length of the fibers was 5 mm-35 mm. The product is a continuous fiber roving, with separation into short fibers taking place only in the fiber spraying process.

Wood parts were used as reinforcing elements. The wood parts embedded in the base had a thickness of around 15 mm; the wood parts embedded in the tub edge had a thickness of around 10 mm.

The bath tub of the invention was produced in accordance with the first process variant described above. To start with, the gelcoat material was sprayed onto the mold, after which the material to form the gelcoat layer was cured at a temperature of 45° C. for 15 minutes. Subsequently the support material was sprayed on and was cured at a temperature of 45° C. for 1 h 30 min.

The thickness of the gelcoat layer on the finished bath tub was between 0.65 mm and 1.1 mm. The typical thickness in regions experiencing little stress, such as the side walls, was around 0.7 mm, the thickness in more greatly stressed regions such as the base was around 0.9 mm, while the thickness in greatly stressed regions such as the tub edge, on which the user often sits or places items of clothing, was 1-1.1 mm.

The thickness of the support varies locally, dependent both on the particular region of the tub and also on whether a reinforcing element is embedded or not.

In regions without reinforcing element, the thickness at the side walls is around 4 mm, and on the base between 9-10 mm.

In regions with reinforcing elements on the tub edge, the thickness of the partial support layer between the gelcoat layer and the reinforcing element is around 1.5 mm, and the partial layer ultimately embedding the reinforcing element has a thickness of around 2.5 mm.

On the base, the partial support layer between the gelcoat layer and the reinforcing element has a thickness of around 4 mm, whereas the partial layer embedding the reinforcing element has a thickness of around 5 mm.

For purposes of comparison a comparative bath tub was produced from the “DuraSolid®” material long used by the applicant, from which known bath tubs are produced. The “DuraSolid®” material consists primarily of natural minerals, resin as binder, and color pigments.

For the production, in a first step, the liquid casting material is introduced into a mold and cured in a drying chamber; in the second step, the solidified bath tub body is dried in a drying oven at temperatures up to 70 degrees. During these drying phases, the material reaches its ultimately curing. The thickness of the tub is around 12 mm in the edge and side regions, around 26 mm at the base.

The weight is already an indication of distinct differences between the bath tub of the invention and the comparative bath tub. While the comparative bath tub weighs around 160 kg, the bath tub of the invention weighs only around 90 kg, meaning that the weight can be reduced by 70 kg, thus by more than 40%.

The mechanical stability as well can be improved by virtue of the construction according to the invention. To this end, a drop test was carried out with a drop weight of 435 g. The drop weight was dropped onto the base of the tub from various heights until the base fractured. The comparative bath tub fractured at an already considerable drop height of 2.5 m, whereas the bath tub of the invention fractured only at a drop height of 4 m. Here as well it is possible to achieve a distinct improvement.

Like the comparative bath tub, the bath tub of the invention as well of course maintained its integrity in the face of the temperature cycling test wherein in accordance with the protocol of DIN EN 14516, the respective bath tubs are exposed in rapid sequence to different temperatures.

In accordance with DIN EN 14688:2018-12 “Sanitary Appliances—Washbasins—functional requirements and test methods”, scratch tests were conducted. In this case, under a test force of 10 N, no scratch may be deeper than 0.1 mm and/or than the overall depth of the outer layer, depending on which value is lower. The bath tub produced in accordance with the invention, and hence the new material, passed this scratch test.

While specific embodiments of the invention have been shown and described in detail to illustrate the inventive principles, it will be understood that the invention may be embodied otherwise without departing from such principles.

We claim:

1. A sanitaryware article, comprising a support which is formed from a cured resin having embedded reinforcing fibers, which defines the shape of the sanitaryware article and which at least on a facing side bears a cured gelcoat layer.

2. The sanitaryware article according to claim 1, wherein the resin of the support is an epoxy resin, a polyester resin, an acrylic resin, a vinyl ester resin or derivatives thereof.

3. The sanitaryware article according to claim 1, wherein the reinforcing fibers take the form of fiber pieces having a length of 1-35 mm and/or a thickness of 10-15 μm, or in that the fibers take the form of fiber mats having a mat weight of 200-600 g/m².

4. The sanitaryware article according to claim 1, wherein the reinforcing fibers are glass fibers.

5. The sanitaryware article according to claim 1, wherein plate-shaped or strip-shaped or profile-shaped reinforcing elements are embedded in the support at one or more positions.

6. The sanitaryware article according to claim 5, wherein the or each reinforcing element is made of wood, plywood, laminated wood, a laminate, more particularly a fiber laminate, or metal, or is a fiberboard.

7. The sanitaryware article according to claim 5, wherein the one or more reinforcing elements are provided in the region of a base, of a tub or basin portion and/or of an edge region of the support.

8. The sanitaryware article according to claim 1, wherein the gelcoat layer is made of a polyester resin, vinyl ester resin or epoxy resin.

9. The sanitaryware article according to claim 1, wherein the gelcoat layer comprises color pigments and/or an antibacterial agent.

10. The sanitaryware article according to claim 1, wherein the gelcoat layer has a thickness of 0.4-1.5 mm, more particularly of 0.5-1.0 mm, and/or in the support has a thickness of 0.5-12 mm in a region without reinforcing element and 0.5-6 mm in a region with reinforcing element.

11. The sanitaryware article according to claim 1, wherein the area of the support that bears the gelcoat layer has at least in portions a surface structuring which is also reproduced in the gelcoat layer, or the surface is at least in portions delustered.

12. The sanitaryware article according to claim 1, wherein the sanitaryware article is a bath tub or a shower tray.

13. A process for producing a sanitaryware, comprising the steps of:
providing a mold and applying a fluid gelcoat material to an area of the mold;
curing the gelcoat material to form a gelcoat layer;
applying a fluid support material comprising a resin and reinforcing fibers to the gelcoat layer, and also optionally one or more reinforcing elements;
curing the support material to form a support; and
removing the sanitaryware article from the mold.

14. The process according to claim 13, wherein, for embedding one or more reinforcing elements, first a first partial layer of the support material is applied, after which the one or more reinforcing elements are applied to the first partial layer, after which a second partial layer of the support material, embedding the reinforcing elements, is applied to the first partial layer and to the one or more reinforcing elements.

15. The process according to claim 13, wherein after the demolding, a facing side of the sanitaryware article, formed by the gelcoat layer, is worked.

16. The process according to claim 15, wherein after the demolding, and optionally before the working of the surface, one or more edge portions of the sanitaryware article are worked and are joined, more particularly bonded, to one or more further components.

17. A process for producing a sanitaryware article, comprising the steps of:
providing a mold and applying a fluid support material comprising a resin and reinforcing fibers and also optionally one or more reinforcing elements to an area of the mold;
curing the support material to form a support;
removing the support from the mold;
applying a fluid gelcoat material to an area of the support; and
curing the gelcoat material to form a gelcoat layer.

18. The process according to claim 17, wherein, for embedding one or more reinforcing elements, first a first partial layer of the support material is applied, after which the one or more reinforcing elements are applied to the first partial layer, after which a second partial layer of the support material, embedding the reinforcing elements, is applied to the first partial layer and to the one or more reinforcing elements.

19. The process according to claim 18, wherein after the formation of the gelcoat layer, a facing side of the sanitaryware article, formed by the gelcoat layer, is worked.

20. The process according to claim 18, wherein after the curing of the gelcoat layer, and optionally before the working of the surface, one or more edge portions of the sanitaryware article are worked and are joined, more particularly bonded, to one or more further components.

21. The process according to claim 13, wherein the gelcoat material is cured at a temperature of 35° C.-55° C. for a time of 5-20 min and the support material is cured at a temperature of 35° C.-55° C. for a time of 1-2 h.

22. The process according to claim 13, wherein the gelcoat material and/or the support material are or is applied by spraying or by means of fine or coarse brush.

23. The process according to claim 13, wherein a support material is used which already comprises fiber pieces, or the fibers are embedded in the form of fiber mats into the support material.

24. The process according to claim 13, wherein the gelcoat material used comprises the following:
resin: 85-95 wt %
pigment: to 7 wt %
antibacterial agent: to 0.5 wt %,
and the support material used comprises the following:
resin: 40-74 wt %
curing agent: 1-5 wt %
glass fiber: 10-25 wt %
filler: 0-50 wt %.

25. The process according to claim 24, wherein the support material comprises the following:
resin: 40-60 wt %
curing agent: 1-3 wt %
glass fiber: 10-13 wt %
filler: 30-50 wt %,
or
resin: 56-74 wt %
curing agent: 1-5 wt %
glass fiber: 10-25 wt %
filler: 0-30 wt %.
